(19) United States
(12) Patent Application Publication
(10) Pub. No.: US 2025/0106552 A1
(43) Pub. Date: Mar. 27, 2025

(54) FLUID-FILLED ACOUSTIC FLOW SHIELD

(71) Applicant: BATTELLE MEMORIAL INSTITUTE, Richland, WA (US)

(72) Inventors: LINNEA E. WEICHT, Seattle, WA (US); EMMA D. COTTER, Milwaukee, WI (US); JOSEPH H. HAXEL, Port Angeles, WA (US)

(73) Assignee: BATTELLE MEMORIAL INSTITUTE, Richland, WA (US)

(21) Appl. No.: 18/900,269

(22) Filed: Sep. 27, 2024

Related U.S. Application Data
(60) Provisional application No. 63/540,797, filed on Sep. 27, 2023.

(51) Int. Cl. H04R 1/44; G10K 11/16; G10K 11/162; H04R 1/02

(52) U.S. Cl. CPC H04R 1/44; G10K 11/161; G10K 11/162; H04R 1/021

(57) ABSTRACT

A hydrophone flow shield and hydrophone assembly including a hollow polyurethane flow shield with one or more features for improving reliable operation and assembly wherein the features include a recess for holding a clamp for securing the shield to the hydrophone, a slot or through hole extending longitudinally in the clamping region but not extending toward a closed end of the shield beyond the clamping region and when sizing of the shield and hydrophone are not closely matched providing for indirect sealing via a gasket that is located between the shield and the hydrophone.

### RELATED APPLICATIONS

This application claims benefit of U.S. Patent Application No. 63/540,797 filed Sep. 27, 2023. This referenced application is hereby incorporated herein by reference in its entirety.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

### Field of the Invention

The invention generally relates to shielding devices for hydrophones and more particularly to hydrophones with flow shielding that provides reduction in pseudo noise compared to real noise thus providing enhanced real noise detection and analysis capability.

### Background Information

Flow noise (or pseudo noise) is caused by turbulent flow past a hydrophone used to measure underwater sound. It can mask propagating sounds of interest, like the sound generated by a marine renewable energy device or vocalizing marine mammals. Generally speaking, flow noise levels increase with flow velocity. Drifting hydrophones (i.e., suspended from a buoy) are often used to mitigate this challenge because they reduce the relative velocity between the hydrophone and the water. However, drifting hydrophones are more labor-intensive to use and cannot be deployed for long periods of time to capture temporal variation in the soundscape or rare events (e.g., vocalization of a species of interest). Flow shields have been used to reduce the effects of flow noise on stationary hydrophones.

Difficulties exist in getting repeatable and reliable results from flow shields. There is not an off-the-shelf flow shield on the market, so flow shields have been made ad hoc by researchers with varying success. A need exists for an improved flow shield that can provide repeatable results. A need exists for a flow shield or flow shield kit that can be readily and reliably assembled in the field to provide improved and reliable acoustic detection.

### SUMMARY

It is an object of some embodiments of the invention to provide an improved flow shield for use with a hydrophone.

It is an object of some embodiments of the invention to provide a flow shield kit allowing reliable assembly of a shield with common hydrophones for improved performance and reliable operation.’

It is an object of some embodiments of the invention to provide an improved flow shield hydrophone assembly.

Embodiments of the invention provide an improved flow shield for use with a hydrophone to provide improved acoustic detection by reducing pseudo-noise detected by a pressure transducer forming part of the hydrophone.

Some embodiments of the invention provide an improved hydrophone assembly that includes a reliably attached flow shield surrounding the pressure transducer of the hydrophone where the shield and the pressure transducer are separated by an intermediate fluid (e.g. oil or water) that occupies the intermediate space.

Some embodiments of the invention provide a flow shield with an annular recess near its open end for receiving a clamp that mounts the shield to the shoulder of a hydrophone thereby entrapping the intermediate fluid therein.

Some embodiments of the invention provide a flow shield with a longitudinally extending slot in the wall of the shield near the open end of the shield where the slot does not extend toward the tip (i.e. closed or distal end of the shield) beyond the shoulder of the hydrophone and more preferably does not extend toward the shield tip beyond a clamp that secures the shield to the hydrophone.

In some embodiments the shield includes both a recess and a slot. Some embodiments may include more than one recess for use with more than one clamp in securing the shield and to the hydrophone.

In some embodiments the shield includes more than a single longitudinally extending slot spaced along the periphery of the open end of the shield.

In some embodiments the slot or slots are closed such that it/they form closed longitudinally extended opening(s), or through holes, generally located near the open end of the shield in proximity to a clamping region where the end or ends of the opening or openings do not extend toward the tip beyond a mounting clamp while the opposite end or ends of the opening or openings (i.e., the portion or portions of the openings nearest the open end of the shield) may or may not extend toward the open end beyond the clamp or clamps.

In some embodiments, the elongated, longitudinally extending slots or openings may have tapered, angled, zig-zag, curved, or snake like configurations with longitudinally extended features.

In some embodiments the inner diameter of the open end of the shield (or at least mounting region of the shield) is larger than a shoulder region of a hydrophone to which it will be fitted, In such situations, a gasket or spacer may be used as an intermediate mounting region body or bridge between the hydrophone and the shield.

In some embodiments of the invention a shield assembly kit is provided with components for creating a shielded hydrophone where the kit may, for example, include:
(1) a shield (e.g. of incompressible polyurethane) having a density approximating that of a surrounding fluid in which the assembly will be immersed,
(2) a clamp,
(3) potentially a fluid (e.g. oil or water) for filling a volume defined by the spacing between the shield and a hydrophone where the fluid has a density approximating that of a surrounding fluid in which the assembly will be immersed.
(4) potentially an annular gasket or other spacer configured to be positioned between a hydrophone shoulder and the shield when their respective ODs and IDs are not sufficiently close in size in a clamping or mounting area.

In a first aspect of the invention, a hydrophone assembly having a pseudo noise reducing shield, includes: (a) a hydrophone including: (1) a hermetic housing having a tip region and a shoulder region; (2) a sound pressure transducer located within the tip region of the housing, wherein the shoulder region has a larger diameter than the tip region and supports the tip region, (b) a hollow shield having a curved closed end and an open end such that longitudinal, circumferential overlap of a portion of the shield and the shoulder exists to allow for circumferential sealing of shield to the shoulder over at least a portion of the overlap region; (c) an entrapped fluid located between the tip region of the hydrophone and the shield; (d) at least one clamp located around the shield in at least a portion of the overlapping region of the shoulder which secures the shield and the shoulder and provides for reliable sealing; and wherein the circumferential sealing of the shield and the shoulder comprises a relationship selected from the group of: (I) direct sealing when an inner diameter of the open end of the shield approximates an outer diameter of the shoulder region of the hydrophone, and (II) indirect sealing via an intermediate gasket located between the shield and the shoulder when an inner diameter of the open end of the shield has a size that is larger than an outer diameter of the shoulder region of the hydrophone such that direct sealing is not possible; wherein the shield includes at least one feature selected from the group of: (i) a recess in the outer diameter of the shield in at least a portion of the overlapping region, wherein the clamp sits, at least partially in the recess; (ii) at least one longitudinally extending slot penetrates a side wall of the shield from the open end to a location that does not extend longitudinally completely through a region occupied by the clamp; (iii) at least one longitudinally extending opening have a slot-like configuration that penetrates a side wall of the shield extending from a longitudinal location occupied by the clamp toward the open end of the shield but does not extend to the open end; (iv) the shield comprises polyurethane with a density that approximates that of a surrounding fluid into which the hydrophone will be located; and (v) the shield has a hardness between shore 60 A to 65 A.

Numerous variations of the first aspect of the invention exist and include for example: (1) the surrounding fluid comprises a fluid selected from group consisting of fresh water, and seawater; (2) the assembly including option I and each of options i, ii, iv, and v; (3) the assembly including option I and each of options i. iii, iv, and v; (4) the assembly including option II and each of options i, ii, iv, and v; (5) the assembly including option II and each of options i. iii, iv, and v; (6) the assembly including option I and option I; (7) the assembly including option I and option ii; (8) the assembly including option I and option iii; (9) the assembly including option I and option iv; (10) the assembly including option I and option v; (11) the assembly including option II and option I; (12) the assembly including option II and option ii; (13) the assembly including option II and option iii; (14) the assembly including option II and option iv; (15) the assembly including option II and option v; (16) the shield having a density selected from at least one of the group of: (i) within 20% of the density of the surrounding fluid; (ii) within 15% of the density of the surrounding fluid; (iii) within 10 of the density of the surrounding fluid; (iv) within 8% of the density of the surrounding fluid; and (v) within 5% of the density of the surrounding fluid; (17) the entrapped fluid has density selected from at least one of the group of: (i) within 20% of the density of the surrounding fluid; (ii) within 15% of the density of the surrounding fluid; (iii) within 10 of the density of the surrounding fluid; (iv) within 8% of the density of the surrounding fluid; and (v) within 5% of the density of the surrounding fluid; (18) the shield has thickness less than one quarter inch; (19) an outer diameter of the shield is in the range of 2 to 6 times a diameter of the hydrophone tip region, and (20) the entrapped fluid includes at least one fluid selected from the group of: (i) a water based fluid, (ii) oil, and (iii) mineral oil.

In a second aspect of the invention, a shield for a hydrophone includes: a polyurethane body providing a generally symmetrical hollow shape about a longitudinal axis extending down a center of the body with the body having a closed end, an open end and a central body joining the ends, wherein the shield is configured for mounting and sealing directly, or indirectly, to a shoulder of a hydrophone and for entrapping a fluid between the shield material and a hydrophone pressure sensor, wherein the shield includes at least one feature selected from the group of: (i) a recess located in proximity to the open end, where the recess defines a circumferential indentation in the body for receiving a clamp; (ii) a longitudinally extending slot that extends from the open end toward the closed end but does not extend beyond a clamping region; and (iii) a longitudinally extending through hole located near the open end and extending toward the closed end but not extending beyond a clamping region.

Numerous variations of the second aspect of the invention exist and include for example many of the variations set forth in association with the first aspect as well as other material and structural variations set forth herein.

Other objects and advantages of various aspects and embodiments of the invention will be apparent to those of skill in the art upon review of the teachings herein. The various aspects and embodiments of the invention, set forth explicitly herein or otherwise ascertained from the teachings herein, may address any one of the above objects alone or in combination, or alternatively may address some other object of the invention ascertained from the teachings herein.

### BRIEF DESCRIPTION OF THE DRAWINGS

FIG. 1A provides an image of a hydrophone showing its distal pressure transducer or hydrophone tip, widened shoulder region and a protective cage.

FIG. 1B provides a prior art image of a hydrophone assembly including a hydrophone of FIG. 1 with an open end of a flow shield mounted to the shoulder of the hydrophone via a clamp with the space between the flow shield and the hydrophone transducer occupied by an oil.

FIG. 1C provides an isometric view of a CAD model of a deployment device for holding two hydrophone configurations for testing purposes.

FIG. 1D provides a photograph of the deployment device of FIG. 1C with a first hydrophone being the unshielded hydrophone of FIG. 1A and a second hydrophone being the shielded hydrophone assembly of FIG. 1B.

FIG. 2 provides an image of a deployment device for holding four differently configured hydrophones for testing purposes with the left most hydrophone including an oil filed polyurethane flow shield of some embodiments of the invention (e.g., the hydrophone flow shield of FIGS. 7A-7D) but without its unique features being visible, the second hydrophone from the left including a ballistic nylon flow shield, the second hydrophone from the right including a thin nylon flow shield, while the right most hydrophone is that of FIG. 1A without any shielding.

FIGS. 3A and 3B, respectively provide a schematic front view (FIG. 3A) of a vertically oriented flow shield of some embodiments of the invention along with a cut view of the flow shield (FIG. 3B) wherein shield includes an upper closed tip, a hollow interior, and a lower mounting region including an external recessed portion that is capable of receiving a mounting clamp for fixedly holding the shield to the shoulder region of a hydrophone.

FIG. 4 provides a front view of a vertically oriented flow shield of some embodiments of the invention that is similar to that FIGS. 3A and 3B but with the addition of a second recess region which is capable of receiving a second retention clamp.

FIG. 5 provides a front view of a vertically oriented flow shield of some embodiments of the invention that lacks the recesses of FIGS. 3A, 3B, and 4 but includes a longitudinally extending notch or slot that starts at the lower open end of the shield and extends upward toward the tip for a distance that is long enough to at least partially engage a clamp that will extend around the periphery of the shield but not so long that it extends longitudinally beyond the clamp.

FIG. 6 provides a front view of a shield of some embodiments which is similar to the clamp of FIG. 5 but where a second slot or notch is included.

FIGS. 7A-7D provides a front view and three different isometric views of a shield where the shield includes both a recess like the embodiment of FIGS. 3A-3B and a slot like that of the embodiment of FIG. 5 where the slot does extend completely through the longitudinal width of the recess.

FIG. 8 illustrates another embodiment where the shield is similar to that of FIGS. 7A-7D but with an additional notch or slot.

FIG. 9 illustrates an additional embodiment, where a slot or notch extends completely through a recess closest to the open end of the shield but does not extend through a second recess located longitudinally above the first recess.

FIG. 10 illustrate an additional embodiment, similar to that of FIG. 9 but with a second notch.

FIG. 11 illustrates another embodiment where the notch/slot of FIG. 5 does extend to the open end of the shield but stops short such that a gap exists in the form of a through hole.

FIG. 12 illustrates a further embodiment where the through hole is used in combination with a recess with the through hole not extending toward the closed end of the shield past the clamping region defined by the recess.

FIG. 13 illustrates an embodiment similar to that of FIG. 9 but with the slot replaced by a through hole.

FIG. 14 illustrates an embodiment with a slot, a through hole, and two recesses where the slot extends partially through the lower recess and the hole extends partially through the upper recess such that the upper recess in combination with a clamp alone may provide attachment and sealing or such that both lower and upper recesses and clamps may be used in combination to potentially enhance attachment and sealing.

FIG. 15 illustrates an alternative embodiment where the shield is similar to that of FIG. 11 but with the elongated through hole being at an angle relative to the longitudinal axis such that it has both a longitudinal and perpendicular component.

FIG. 16 illustrates an alternative embodiment wherein the shield has an elongated slot extending from the lower open end of the shield toward the closed end but with the slot having not only a longitudinally extending orientation but also a right-left zig-zag configuration.

FIG. 17 illustrates an alternative embodiment wherein the shield has an elongated opening that has an upward facing chevron configuration.

FIG. 18 illustrates an alternative embodiment wherein the shield has an elongated, longitudinally extended opening but with a narrowing width as the slot extends from the open end of the shield toward the mounting region.

FIGS. 19A-19C respectively provide a front view of a shield (FIG. 19A), an unassembled cut view of the shield having an ID, a hydrophone having a shoulder OD and an annular gasket that has sufficient radial width to bridge the gap between the OD and the ID (FIG. 19B), and the assembled shield, hydrophone, and gasket (without showing a clamp) (FIG. 19C).

### DETAILED DESCRIPTION OF THE INVENTION

Various advantages and novel features of the present invention are described herein and will become even more apparent to those skilled in this art from the following detailed description. In the preceding and following descriptions a preferred embodiment of the invention is set forth by way of illustration of the best mode contemplated for carrying out the invention. As will be apparent to those of skill in the art after reviewing the disclosure set forth herein, embodiments of the invention are capable of modification in various respects without departing from the spirit of invention. Accordingly, the drawings and description of the embodiments set forth herein are to be regarded as illustrative in nature, and not as restrictive.

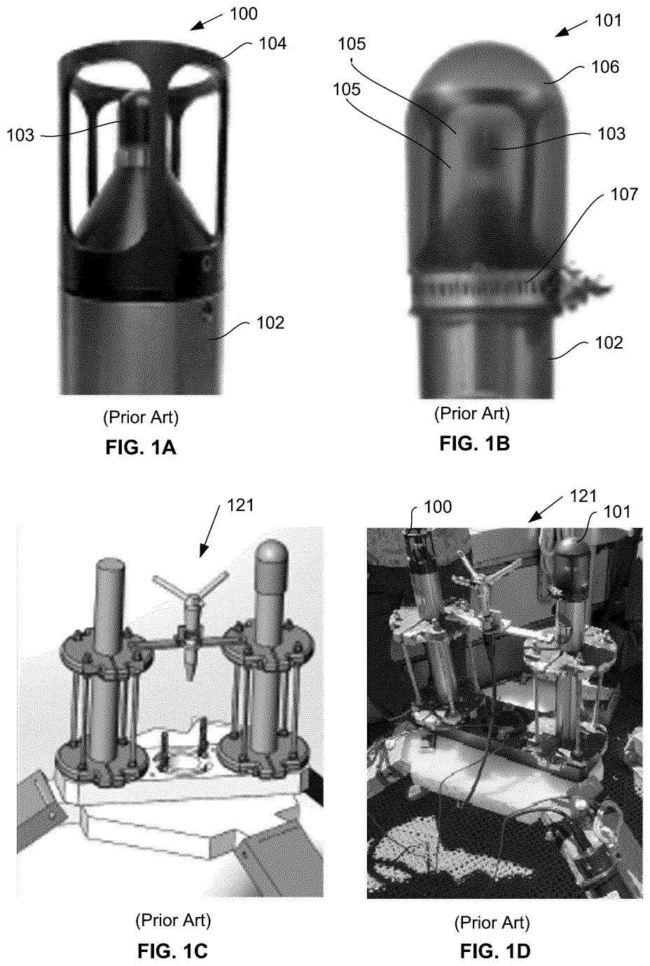

FIG. 1A provides an image of a detection end of a hydrophone 100 showing its distal pressure transducer tip 103, widened shoulder region 102 and a protective cage 104.

FIG. 1B provides a prior art image of the detection end of a hydrophone assembly 101 that includes the hydrophone 100 of FIG. 1 with a hollow urethane flow shield 106 encapsulating the detection end of the hydrophone with an open end of the shield surrounding the shoulder 102 of the hydrophone and sealed thereto via a clamp 107 with the space 105 between the flow shield 106 and the hydrophone transducer 103 occupied by an oil 105′.

FIG. 1C provides an isometric view of a CAD model of a deployment device 121 holding two hydrophones and a detector for measuring flow speed of a surrounding fluid that can generate pseudo-noise as it flows past the hydrophones while FIG. 1D provides a photograph of the deployment device with one of the hydrophones being the unshielded hydrophone 100 of FIG. 1A and the other being the shielded hydrophone assembly 101 of FIG. 1B.

FIGS. 1A-1D were included in a Sep. 14, 2022 presentation made at the UMERC+METS 2022 Conference (https://tethys.pnnl.gov/events/umercmets-2022-conference) based on the work of the inventors and entitled “Quantitative Evaluation of Four Flow Shield Designs. The abstract for this presentation and the annotated presentation slides are incorporated herein by reference as if set forth in full.

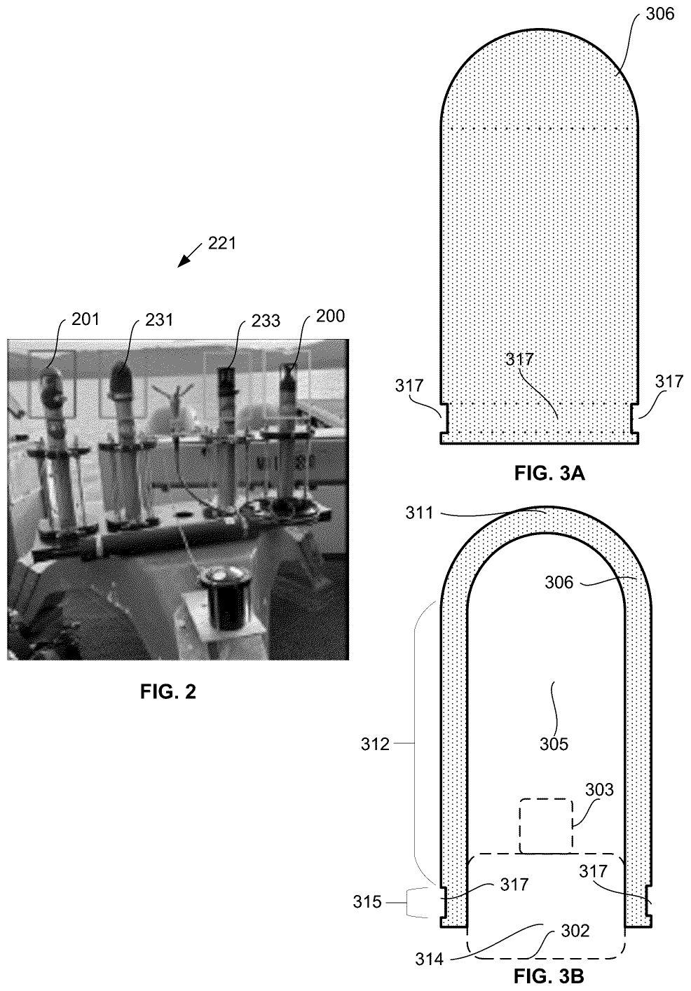

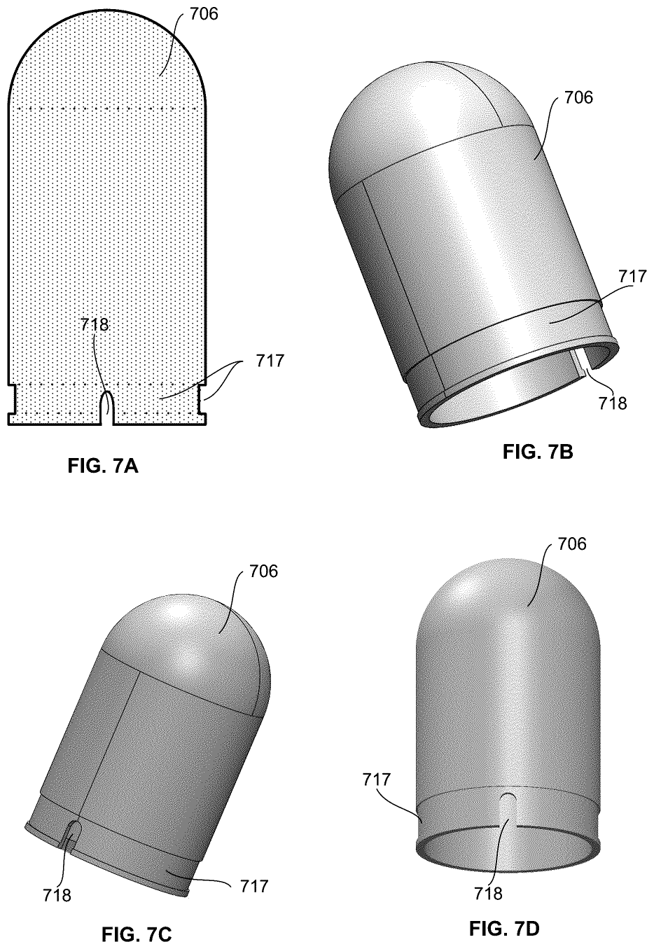

FIG. 2 provides an image of an alternative deployment device 221 for holding four differently configured hydrophones or hydrophone assemblies. As shown the left most hydrophone is in the form of an assembly 201 that includes an oil filled urethane shield clamped to the transducer end of the hydrophone with an oil occupying the enclosure defined by the shield and is similar to that of FIG. 1B but with additional shield enhancements (not visible) that provide for improved operational reliability. Some of the shield enhancements are shown in the detailed images of FIGS. 7A-7D. The second hydrophone assembly 231 from the left includes a ballistic nylon shield that allows surrounding fluid to enter shielded volume but inhibits fluid flow therethrough. The second hydrophone assembly 233 from the right includes a thinner nylon flow shield which allows surrounding fluid to enter the shielded volume while still providing a reduction in fluid flow through shielded region. The right most hydrophone 200 is unshielded and used for collecting baseline data for performance comparisons during testing of shield performance. The four hydrophones of FIG. 2 are SoundTrap ST600 HF hydrophones from Ocean Instruments of Auckland, New Zealand which has a transducer diameter of 1.5 centimeters. The deployment device which holds the hydrophones is a Sea Spider lander from Oceanscience of Carlsbad, California. Experiments with the setup of FIG. 2 were described by the inventors in a paper dated Jan. 10, 2024, published in edition (Volume 4, Issue 1) of the JASA Express Letters of the Acoustical Society of America (https://doi.org/10.1121/10.0024333). This Jan. 10, 2024, publication is incorporated herein by reference as if set forth in full herein).

FIGS. 3A and 3B, respectively provide a schematic front view of a vertically oriented flow shield 306 (FIG. 3A) and a cut view of the flow shield (FIG. 3B) of some embodiments of the invention wherein shield includes a hollow interior 305, curved closed tip region 311, and extended body region 312 and an open end 314 providing an opening for receiving a hydrophone tip 303 and shoulder 302 with a mounting region 315 located near the open end. The shield includes an external annular recessed portion 317 that is capable of receiving a mounting clamp (not shown) for fixedly holding the shield to the shoulder region 302 of a hydrophone. The recess provides a defined position location for a clamp but also, particularly in the case of an incompressible shield material, a reduced amount of shield material that must be displaced when sealing the shield to the hydrophone shoulder. In some embodiments, the shield is formed of a polyurethane material having a density approximating that of the surrounding fluid (e.g. fresh water or seawater). When combined with a hydrophone, the shield provides an enclosed volume that can hold an interior or encapsulated fluid that is the same or different from the surrounding fluid. During assembly of the shield, interior fluid, and the hydrophone, the interior fluid is made to occupy all portions of the interior of the shield cavity to minimize or eliminate existence of trapped gases and bubbles which could negatively impact operational performance.

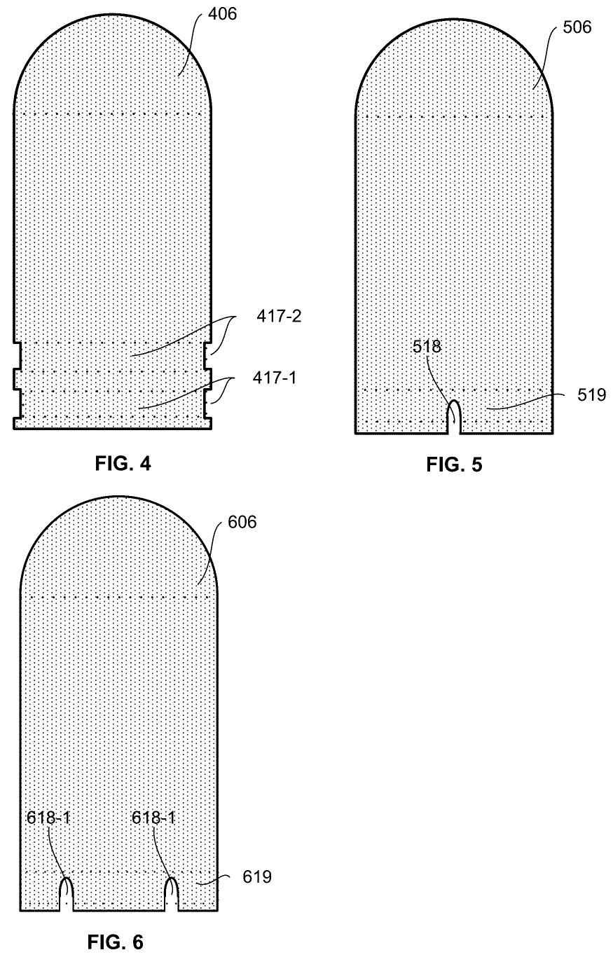

FIG. 4 provides a front view of a vertically oriented flow shield 406 of some embodiments of the invention that is similar to that FIGS. 3A and 3B but with the addition of a second recess region 417-2 in addition to the first recess region 417-1 for holding a second retention clamp and potentially improving the retention of the shield to the hydrophone or improving retention of an encapsulated fluid during use. In some variations, only one of the two recesses may receive a clamp while in other embodiments, both recesses may receive clamps.

FIG. 5 provides a front view of a vertically oriented flow shield 506 of some embodiments of the invention that lacks the recesses of FIGS. 3A, 3B, and 4 but includes a longitudinally extending notch or slot 518 that starts at the open end of the shield and extends upward toward the tip for a distance that is long enough to partially engage a clamp at non-recessed clamping region 519 that extends around the periphery of the shield. The extension of the notch or slot is not so long that it would extend toward the tip beyond the clamping region. The existence of the notch provides a region for material displacement, which may be particularly important when the shield material is non-compressive (as is the shield material of some embodiments of the invention), as the compressive force from the clamp needs to displace material to cause sealing, sealing enhancement, attachment, and/or attachment enhancement. In some variations the notch or slot may have an elongated configuration that extends longitudinally as shown while in others it may have not only a longitudinal component of extension but a perpendicular or lateral component as well. In some variations, the elongated path of the notch may not be straight but be curved, zig-zagged, or have a different pattern that allows movement of shield material into the notch during compression and potentially even face-to-face closure of the side wall features against one another upon compression along part or all of the length of the notch. In some embodiments, the notch may have a uniform width prior to compression or alternatively have width that varies over its length.

FIG. 6 provides a front view of a shield 606 of some embodiments of the invention which is similar to that of FIG. 5 but where slot 518 is replaced by two laterally displaced slots. A first slot 618-1 and a second slot 618-2 are included to provide more regions for movement of the shield material under a compressive force from a clamp. In other variations more than 2 slots may be included. Neither slot of FIG. 6 extends beyond a clamping region defined by 619 and more preferably beyond a longitudinal positioning of a clamp that will be positioned in the clamping region during assembly. In some variations, a slot or slot may extend beyond a clamping region if a more distal clamp will be used to enhance sealing.

FIGS. 7A-7D provide different views of another embodiment of the invention where shield 706 includes both a recess 717 like that 317 of FIGS. 3A-3B and a notch or slot 718 like 518 of FIG. 5A where the notch does not extend completely through the longitudinal width of the recess. The embodiment of FIG. 7A-7D is the shield configuration of assembly 201 of FIG. 2 which can't be ascertained from FIG. 2. The shield of FIGS. 7A-7D may be formed from a polyurethane as was shield 201.

In the various embodiments herein, the polyurethane shield material may have a density approximating that of the surrounding fluid into which the hydrophone assembly will be immersed. In different variations such shields may have densities in the range of 80% to 120% of that of the surrounding fluid, within 85% to 115% of that of the surrounding fluid, within 90% to 110% of the surrounding fluid, within 92% to 108% of the surrounding fluid, or even more narrowly within 95% to 105% of the surrounding fluid. Surrounding fluids, for example may be fresh water, seawater, or other fluids/liquids in which sound measurements are of interest.

In various embodiments herein, density of a trapped or encapsulated fluid preferably approximates that of the surrounding fluid and in different variations may have densities in the range of 80% to 120% of that of the surrounding fluid, within 85% to 115% of that of the surrounding fluid, within 90% to 110% of the surrounding fluid, within 92% to 108% of the surrounding fluid, or even within 95% to 105% of the surrounding fluid. In some embodiments, the trapped or encapsulated fluid may, for example, be an oil, such as a mineral oil. or a water based liquid.

Tested shields used wall thicknesses in the ⅛ inch range while it is believed that variations may use wall thickness considerable thinner (e.g., 1/16 inch or less) or considerably thicker (e.g. up to ¼ inch or even ½ inch).

Tested shields had hardnesses in the shore 60 A to 65 A range while it is believed that variations may be made to work with lower or higher hardnesses.

Tested shields had relatively smooth surface finishes but it is believed functional variations may work with different surfaces finishes.

A depth of a shield recess most preferably approximates that of the clamp which it will hold (e.g., within 20% or even more preferably within 10% of the clamp thickness) but may be significantly less or significantly greater than that of the clamp (e.g. a recess thickness of up to one half of the shield wall thickness or more) may be acceptable in some embodiments. For example a clamp with a 0.025 inch thickness may be placed in a recess having a 0.023″ thickness. Recess widths are preferably wide enough to capture the width of a clamp. For example a 0.5″ width will fit most clamps, but wider recesses (e.g. up to 1″ or more) or even narrower recesses may be used as appropriate.

Slot or notch widths of ¼″ have been tested with ⅛″ shields, however, it is believed that narrower widths or wider widths may be effectively used as well.

Preferred shield diameters will be in the range of 2-6 times the diameter of a hydrophone transducer tip and more preferably in the range of 3-5 times that of the transduce tip. It is believed that smaller or larger shield diameters may be effective under some circumstances.

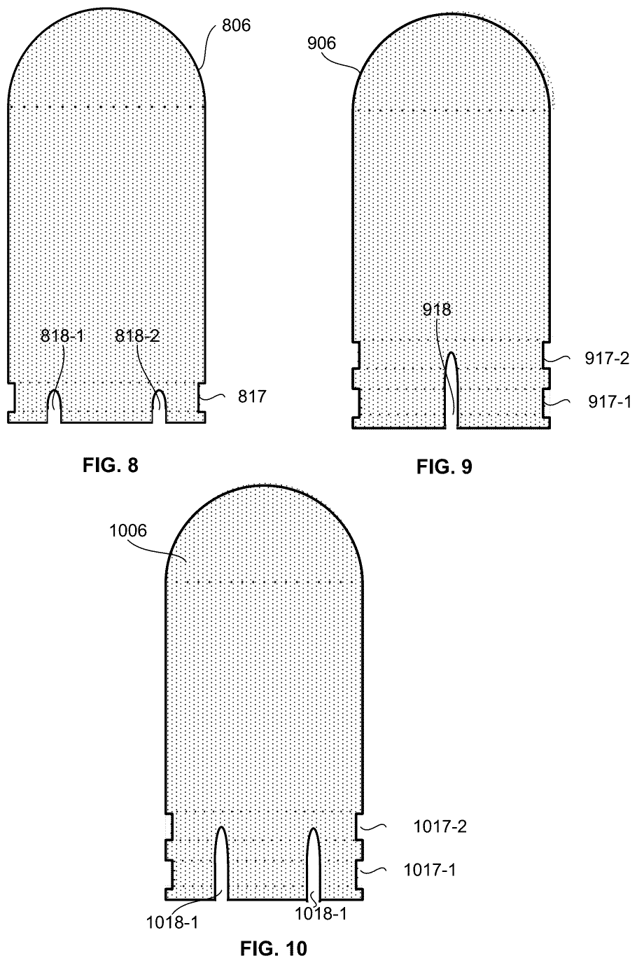

FIG. 8 illustrates another embodiment where shield 806 is similar to that of FIGS. 7A-7D but with slot 718 replaced by a pair of slots 818-1 and 818-2.

FIG. 9 illustrates an additional embodiment, where slot or notch 918 extends completely through a recess 917-1 closest to the open end of the shield but does not extend completely through a second recess 917-2 and preferably extends from an open end of the shield to within lower and upper longitudinal extents of a clamp located in recess 917-2 but not beyond the upper longitudinal extent of the clamp that is located in recess 917-2 during assembly.

FIG. 10 illustrates an additional embodiment, similar to that of FIG. 9 but with slot 918 replaced by two laterally separated slots 1018-1 and 1018-2.

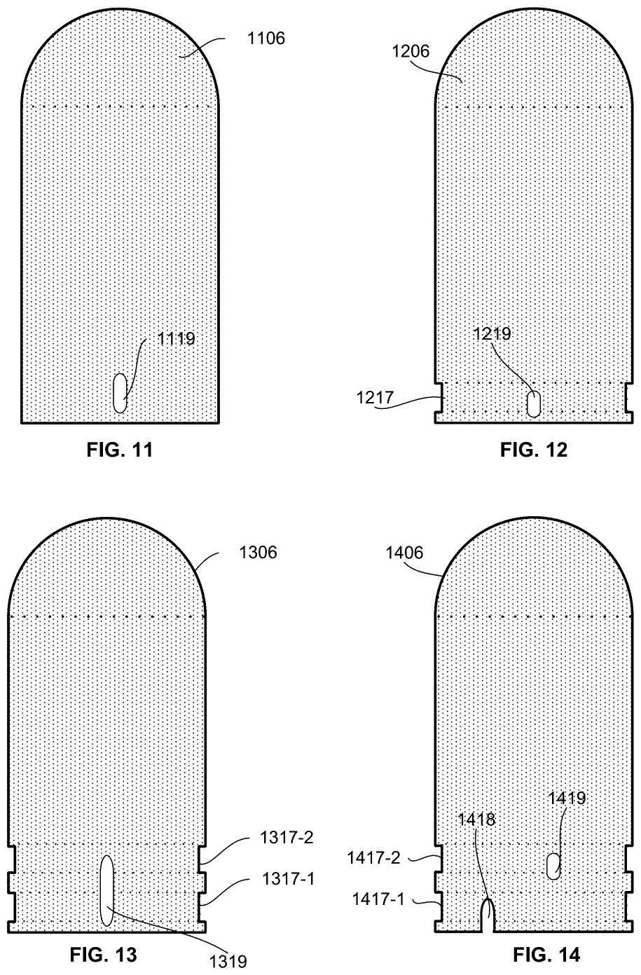

FIG. 11 illustrates another embodiment where slot 518 of FIG. 5 is modified to become through hole or opening 1119 in shield 1106 which does not extend downward to the open end of the shield but may or may not extend downward to a position below a longitudinal position of a clamp that will be used to hold the shield and hydrophone together. In preferred embodiments through hole 1119 would not extend upward beyond the longitudinal upper extent of a clamp that will hold the shield unless a second clamp above the first clamp would overlay the upper end of the slot.

FIG. 12 illustrates a shield 1206 similar to shield 706 of FIG. 7A-7D but with the slot 718 converted to a through hole 1219 with the lower end of the through hole extending below the lower longitudinal extent of the recess 1217 and the upper extent of the through hole not extending beyond an upper longitudinal extent of recess 1217 and even more preferably not beyond the upper extent of a clamp that will occupy the recess. In other embodiment the through hole may not extend below or above the longitudinal extents of a clamp occupying the recess.

FIG. 13 illustrates shield 1306 with two recesses 1317-1 and 1317-2 and a single through hole 1319 that extends through the bottom recess and part way through the upper recess.

FIG. 14 illustrates a further shield embodiment where the shield 1406 includes both a slot 1418 and a through hole 1419 with each occupying a lower portion of different recesses 1417-1 and 1417-2, respectively, where the through hole and the slot are spaced laterally apart such that each clamp not only can provide improved attachment but also improved sealing.

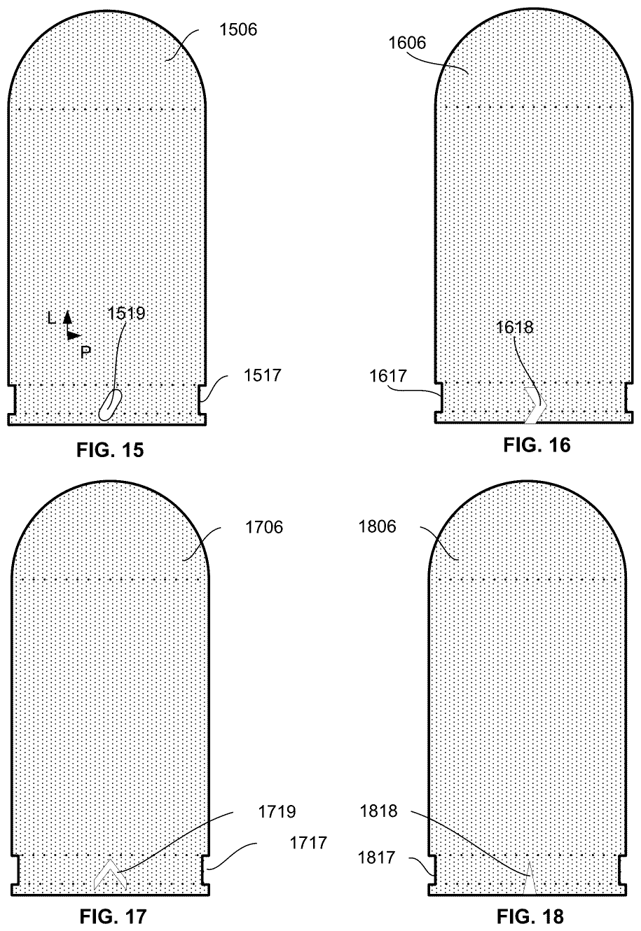

FIG. 15 illustrates another shield embodiment where the shield 1506 includes a through hole 1519 where the shield is similar shield 1106 but with the elongated opening or through hole 1519 having both a longitudinal component of extension L and a perpendicular (lateral or circumferential) component of extension P.

FIG. 16 illustrates an additional shield embodiment wherein the shield 1606 has an elongated slot 1618 extending from the lower or open end of the shield (at the bottom of the shield) longitudinally toward the closed or upper end of the shield but with the slot having a linear longitudinal configuration replaced with a right-left zig-zag configuration. In other variations, the zig-zag may have additional segments and/or may have rounded connections such that the overall shape is curved or a combination of lines and curves. In still other embodiments, the slot may not reach the lower extent of the shield and thus take the form of a through hole.

FIG. 17 illustrates an alternative embodiment wherein the shield 1706 has an elongated opening 1719 having a width of the individual elements that is narrower than a total longitudinal length of the opening wherein the opening has an upward facing chevron or inverted V configuration where the highest longitudinal extent of the opening does not extend past the upper longitudinal extent of recess 1717 or more preferably beyond an upper longitudinal position of a clamp that is used in assembling the shield to a hydrophone.

FIG. 18 illustrates an alternative embodiment wherein the shield 1806 includes recess 1817 and an elongated longitudinally extended slot 1818 with a narrowing width (e.g. an inverted V shape or triangular shape as the slot extends from the open end of the shield toward the mounting region. As clamping occurs it believed the upper end of the slot will close first as the compressive force of the clamp causes movement of shield material with continued compression resulting in propagation of the closure or narrowing toward the open end of the shield. In some variations, for example, the slot may be replaced by a through hole of similar configuration or a through hole with a diamond-like shape such that closure or narrowing of upper and lower portions of the opening may occur prior to any closure of middle portions of the through hole.

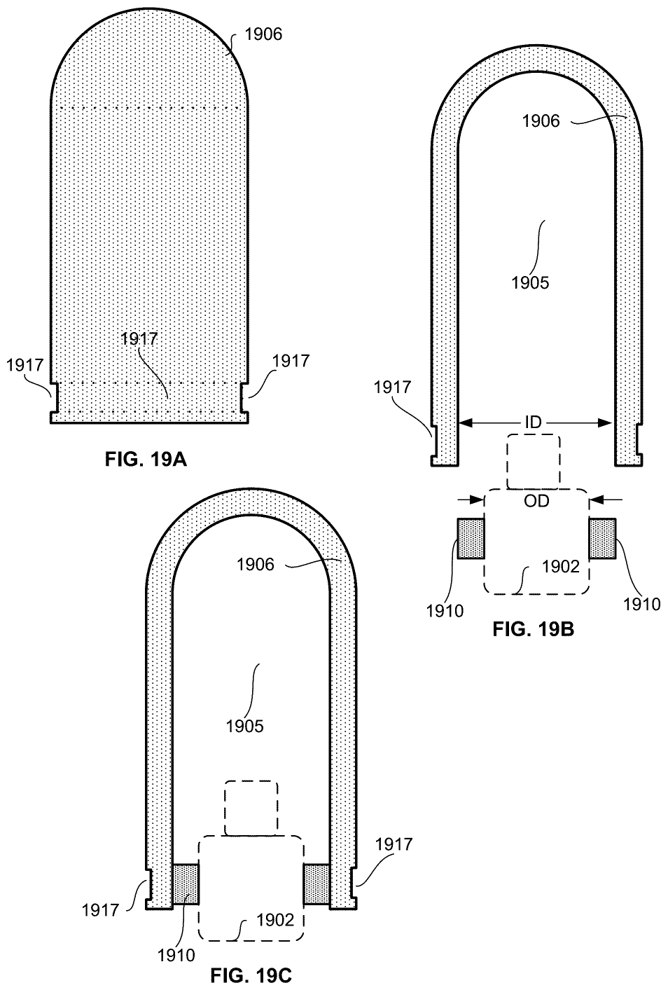

FIG. 19A illustrates a shield similar to that of FIG. 3A while FIG. 19C provides an assembly of that shield and a hydrophone (without a clamp being shown) similar to that of FIG. 3B but with an annular gasket, shim, or spacer bridging a gap between a hydrophone shoulder OD and a mounting region ID of the shield, and with FIG. 19B showing an intermediate state with the hydrophone and shield laterally aligned but not yet longitudinally engaged. In FIG. 19A-19C shield 1906 has an inner diameter (ID) that is larger than an outer diameter (OD) of a shoulder 1902 of a hydrophone that is to be used in an assembly. More specifically the larger ID is too large to allow reliable sealing of the shield 1906 to the hydrophone shoulder by a clamp alone. In the embodiment of FIGS. 19A-19C an annular gasket or spacer 1910 is provided that can bridge the gap between the hydrophone shoulder and shield such that clamping can effectively be used in assembling the shield and the hydrophone. In variations of the embodiment of FIGS. 19A-19C, the gasket or spacer may be formed in whole or in part of a compressible material (e.g. Buna-N rubber with a shore 50 A hardness) to aid in it fitting and sealing to the hydrophone and sealing to the shield under a compressive force provided by a clamp. In some variations the gasket may include an outer rigid material and an inner compressible or deformable material. In other variations, multiple gaskets may be placed at different longitudinal positions to aid in ensuring alignment of longitudinal axes of the hydrophone and shield. In some variations, an assembly guide may be used to ensure proper positioning of the gasket and shield relative to the hydrophone when clamping wherein the guide may remain or be removed prior to usage. In some embodiments the gaskets may be longitudinally longer or shorter than a longitudinal width of a clamp or positioning recess. In some variations, the gaskets may have leading edge and/or trailing edge slopes or rounded edges to aid in relatively sliding them onto the hydrophone or into the shield. Numerous other variations of the embodiment of FIGS. 19A-19C are possible and include, for example, shield modifications that incorporated one or more slots or through holes with longitudinally extended configurations that can aid in allowing shield material movement for improved sealing. Other variations, for example, might include one or more additional recesses for positioning additional clamps.

In different embodiments of the invention, shields may be mounted to hydrophones using different types of clamps. Such clamps may for example include screw-type hose clamps, quick release clamps, high-torque bolt-on clamps, spring clamps, and/or custom metal or plastic clamps. In some embodiments, sealing and attachment may be achieved via bonding instead of or in addition to clamping.

The urethane or polyurethane shield material of the shield is anticipated to be robust to biofouling and marine degradation. In a side-by-side comparison, as documented in the previously noted JASA paper, the oil-filled shield performed better and is more robust to the marine environment. It is anticipated that some embodiments of the invention will enhance the viability of a commercial off-the-shelf flow shield that may be used with common commercially available hydrophones, to provide a more standardized approach to flow noise reduction while also significantly reducing time and effort required by users. Potential applications include but are not limited to: (1) monitoring noise emissions from offshore renewables; (2) monitoring noise emissions from other offshore anthropogenic activities (e.g., construction), and (3) monitoring marine mammals or other vocalizing or tagged animals. Shielded hydrophones of the various embodiments of the invention may be used in association with stationary delivery systems or alternatively they may be used in moving applications such on boats, manned or unmanned underwater vehicles or the like.

Numerous variations of the above embodiments exist. Some such variations may take one or more features found in one embodiment being inserted into another embodiment with or without removing features from the target embodiment. For example, in some embodiments, additional recesses may be added, additional through holes may be added, additional slots or notches may be added, one or more gaskets, shims, or spacers may be added with them spaced from one another, stacked longitudinally, or radially. Shields may include anti-biofouling coatings (e.g. creams or paints) such as coating including zinc oxide. Shields may be used in conjunction with protective cages or may be used without such protective cages. Shields may have bulbous configurations different from the cylindrical body, semi-circular closed end configurations illustrated herein.

### Final Remarks

It is intended that the aspects of the invention set forth specifically herein or otherwise ascertained from the present teachings represent independent invention descriptions which Applicant contemplates as full and complete, and that Applicant believes may be set forth as independent claims without need of importing additional limitations or elements from other embodiments or aspects set forth herein for interpretation or clarification. It is also understood that any variations of the aspects (as well as variations in any embodiments) set forth may form the basis for independent claims and/or dependent claims.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention.

We claim:

1. A hydrophone assembly having a pseudo noise reducing shield, comprising:
a. a hydrophone comprising:
(1) a hermetic housing having a tip region and a shoulder region;
(2) a sound pressure transducer located within the tip region of the housing, wherein the shoulder region has a larger diameter than the tip region and supports the tip region,
b. a hollow shield having a curved closed end and an open end such that longitudinal, circumferential overlap of a portion of the shield and the shoulder exists to allow for circumferential sealing of shield to the shoulder over at least a portion of the overlap region;
c. an entrapped fluid located between the tip region of the hydrophone and the shield;
d. at least one clamp located around the shield in at least a portion of the overlapping region of the shoulder which secures the shield and the shoulder and provides for reliable sealing; and
wherein the circumferential sealing of the shield and the shoulder comprises a relationship selected from the group consisting of:
I. direct sealing when an inner diameter of the open end of the shield approximates an outer diameter of the shoulder region of the hydrophone, and
II. indirect sealing via an intermediate gasket located between the shield and the shoulder when an inner diameter of the open end of the shield has a size that is larger than an outer diameter of the shoulder region of the hydrophone such that direct sealing is not possible;
wherein the shield comprises a feature selected from the group consisting of:
i. a recess in the outer diameter of the shield in at least a portion of the overlapping region, wherein the clamp sits, at least partially in the recess;
ii. at least one longitudinally extending slot penetrates a side wall of the shield from the open end to a location that does not extend longitudinally completely through a region occupied by the clamp;
iii. at least one longitudinally extending opening have a slot-like configuration that penetrates a side wall of the shield extending from a longitudinal location occupied by the clamp toward the open end of the shield but does not extend to the open end;
iv. the shield comprises polyurethane with a density that approximates that of a surrounding fluid into which the hydrophone will be located; and
V. the shield has a hardness between shore 60 A to 65 A.

2. The assembly of claim 1 wherein the surrounding fluid comprises a fluid selected from group consisting of (1) fresh water, and (2) seawater.

3. The assembly of claim 1 comprising Markush option I and each of Markush options i, ii, iv, and v.

4. The assembly of claim 1 comprising Markush option I and each of Markush options i. iii, iv, and v.

5. The assembly of claim 1 comprising Markush option II and each of Markush options i, ii, iv, and v.

6. The assembly of claim 1 comprising Markush option II and each of Markush options i. iii, iv, and v.

7. The assembly of claim 1 comprising Markush option I and Markush option i.

8. The assembly of claim 1 comprising Markush option I and Markush option ii.

9. The assembly of claim 1 comprising Markush option I and Markush option iii.

10. The assembly of claim 1 comprising Markush option I and Markush option iv.

11. The assembly of claim 1 comprising Markush option I and Markush option v.

12. The assembly of claim 1 comprising Markush option II and Markush option i.

13. The assembly of claim 1 comprising Markush option II and Markush option ii.

14. The assembly of claim 1 comprising Markush option II and Markush option iii.

15. The assembly of claim 1 comprising Markush option II and Markush option iv.

16. The assembly of claim 1 comprising Markush option II and Markush option v.

17. The assembly of claim 1 wherein the shield has a density selected from the group consisting of:
i. within 20% of the density of the surrounding fluid;
ii. within 15% of the density of the surrounding fluid;
iii. within 10 of the density of the surrounding fluid;
iv. within 8% of the density of the surrounding fluid; and
v. within 5% of the density of the surrounding fluid.

18. The assembly of claim 1 wherein the entrapped fluid has density selected from the group consisting of:
i. within 20% of the density of the surrounding fluid;
ii. within 15% of the density of the surrounding fluid;
iii. within 10 of the density of the surrounding fluid;
iv. within 8% of the density of the surrounding fluid; and
v. within 5% of the density of the surrounding fluid.

19. The assembly of claim 1 wherein the shield has thickness less than one quarter inch.

20. The assembly of claim 1 wherein an outer diameter of the shield is in the range of 2 to 6 times a diameter of the hydrophone tip region.
